(19) United States
(12) Patent Application Publication
(10) Pub. No.: US 2009/0027615 A1
(43) Pub. Date: Jan. 29, 2009

(54) Connecting structure for glass frame and wearing portion

(76) Inventor: Lin Yun Chen, An Ting Shiang (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/878,330

(22) Filed: Jul. 24, 2007

(51) Int. Cl. G02C 1/00; G02C 5/16

(52) U.S. Cl. 351/86

(57) ABSTRACT

A pair of glasses includes a frame and a wearing portion. The frame includes a groove in an end thereof. The groove includes an end opening facing a rear of the frame. The groove further includes a side opening in a lateral face of the end of the frame. The wearing portion includes an engaging member having a resilient tenon. The engaging member is removably engaged with the groove of the frame via the end opening, and the resilient tenon is engaged with the side opening. The resilient tenon of the engaging member is pressable into the groove of the frame to disengage from the side opening, allowing removal of the engaging member from the groove.

### BACKGROUND OF THE INVENTION

1. Field of the Invention

The present invention relates to a connecting structure for a glass frame and a wearing portion and, more particularly, to a connecting structure allowing replacement of the glass frame or the wearing portion.

2. Description of the Related Art

A pair of optical glasses generally includes a frame and two temples on two sides of the frame. Optical lenses for correcting myopia, hyperopia, or astigmatism are mounted in the frame. Sunglasses are generally utilized to shield the eyes of a user from sunlight while various types of goggles are available for sports, leisure, industry, skiing, etc. As a result, users must carry several pairs of glasses or goggles for different needs.

The present invention is intended to obviate and/or mitigate this problem.

### SUMMARY OF THE INVENTION

A pair of glasses in accordance with a first aspect of the present invention includes a frame and a wearing portion. The frame includes an end having a groove defined therein. The groove includes an end opening facing a rear of the frame. The groove further includes a side opening in a lateral face of the end of the frame. The wearing portion includes an engaging member having a resilient tenon. The engaging member is removably engaged with the groove of the frame via the end opening, and the resilient tenon is engaged with the side opening. The resilient tenon of the engaging member is pressable into the groove of the frame to disengage from the side opening, allowing removal of the engaging member from the groove.

The wearing portion may be a temple having an end on which the engaging member is formed. A nose pad may be removably mounted to an inner side of the frame; and a pair of optical glasses may be removably mounted to the nose pad and includes at least one corrective lens for correcting one of myopia, hyperopia, or astigmatism.

A pair of glasses in accordance with a second aspect of the present invention includes a first frame and a wearing portion. The first frame includes an end having a groove defined therein. The groove includes an end opening facing a rear of the first frame. The groove further includes a side opening in a lateral face of the end of the first frame. The wearing portion includes a second frame and a head strap attached to the second frame. The second frame is a glasses frame for sports, leisure, eye-protection, or wind-shielding. The second frame receives the first frame and further includes an engaging member having a resilient tenon. The engaging member is removably engaged with the groove of the first frame via the end opening, and the resilient tenon is engaged with the side opening of the groove of the first frame. The resilient tenon of the engaging member is pressable into the groove to disengage from the side opening of the groove, allowing removal of the engaging member from the groove.

A nose pad may be removably mounted to the inner side of the frame. A pair of optical glasses may be removably mounted to the nose pad and includes at least one corrective lens for correcting one of myopia, hyperopia, or astigmatism. The pair of optical glasses is sandwiched between the first frame and the second frame.

A user may replace the wearing portion easily by the simple engaging member with a resilient tenon.

Other objectives, advantages, and features of the invention will become more apparent from the following detailed description when taken in conjunction with the accompanying drawings.

### BRIEF DESCRIPTION OF THE DRAWINGS

FIG. 1 shows a perspective view of a pair of glasses of first type according to preferred teachings of the present invention.

FIG. 2 is an exploded perspective view of the pair of glasses of FIG. 1.

FIG. 3 is a cross sectional view of the pair of glasses of FIG. 1.

FIG. 4 shows a perspective of a pair of glasses of second type according to the preferred teachings of the present invention.

FIG. 5 shows an exploded perspective view of the pair of glasses of FIG. 4.

### DETAILED DESCRIPTION OF THE PREFERRED EMBODIMENTS

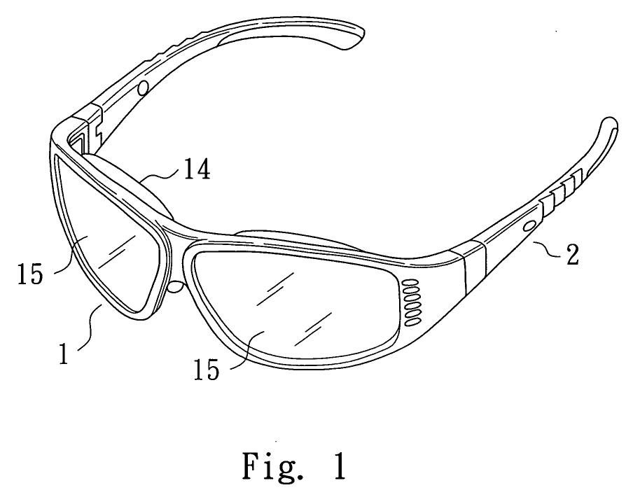

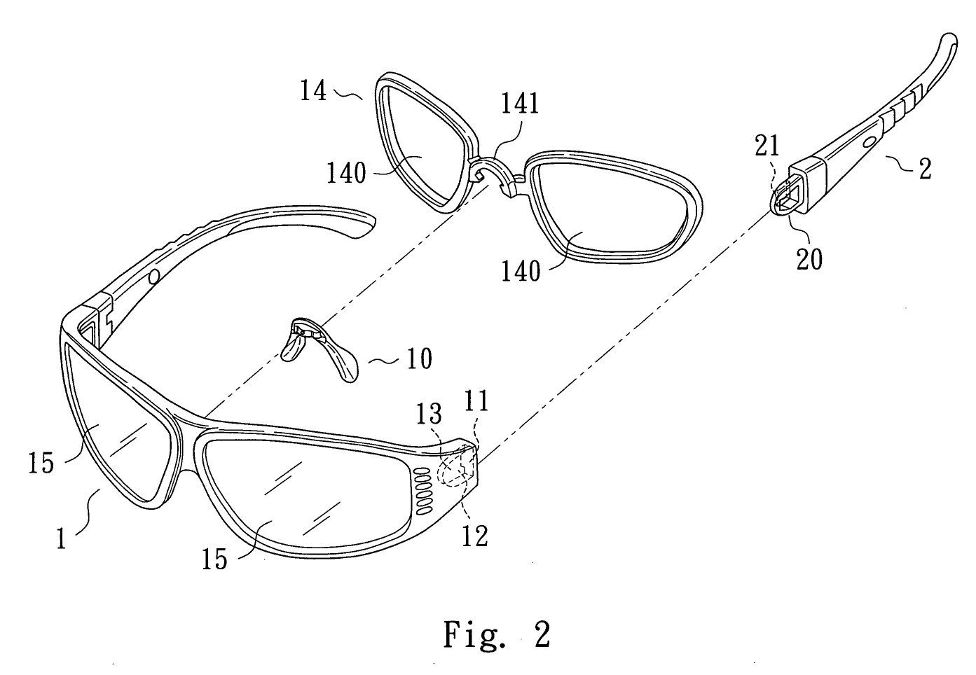

A pair of glasses of first type according to the preferred teachings of the present invention is shown in FIGS. 1 to 3 and includes a frame 1 and two lenses 15 mounted in the frame 1. The frame 1 includes two ends each having a groove 12 defined therein. The groove 12 includes an end opening 11 facing a rear of the frame 1 and a side opening 13 in a lateral face (e.g., the inner face) of the end of the frame 1 and extending in a direction transverse to the rear opening 11. A nose pad 10 is mounted to an inner side of the frame 1. Removably mounted to the nose pad 10 is a pair of optical glasses 14 including two corrective lenses 140 for correcting myopia, hyperopia, or astigmatism and a connecting member 141 between the corrective lenses 140. The connecting member 141 is coupled with the nose pad 10, with the pair of optical glasses 14 located behind the frame 1 and with the corrective lenses 140 aligned with the lenses 15. The lenses 15 may be sunglass lenses. Thus, a user may obtain sunlight shielding effect as well as eyesight correction effect. Nevertheless, the lenses 15 may be corrective lenses when desired. The frame 1 may receive only one lens, and the shape of the frame 1 may be modified according to the shape of the lens. Similarly, the pair of optical glasses 14 may include only one corrective lens if desired, and the shape of the pair of optical glasses 14 may be modified according to need.

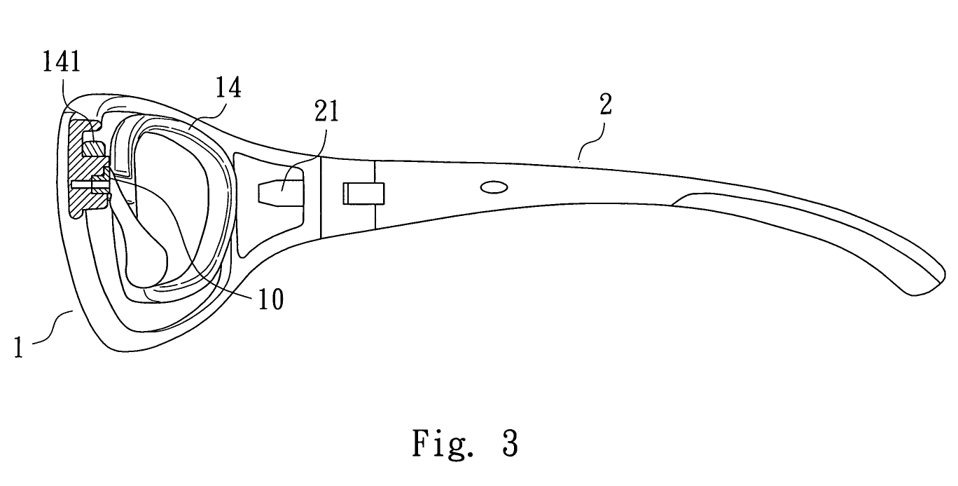

The pair of glasses further includes a wearing portion 2 allowing the pair of glasses to be worn on a head of a user. According to the preferred form shown, the wearing portion 2 is in the form of two temples each including an end having an engaging member 20 with a resilient tenon 21. The engaging member 20 of each temple is inserted into one of the grooves 12 of the frame 1 via the end opening 11, with the resilient tenon 21 engaged with the side opening 13 (see FIG. 3). The resilient tenon 21 can be pressed into the groove 12 and, thus, disengage from the side opening 13, allowing removal of the engaging member 20 from the groove 12. Thus, the temples can be detached from the frame 3 when desired.

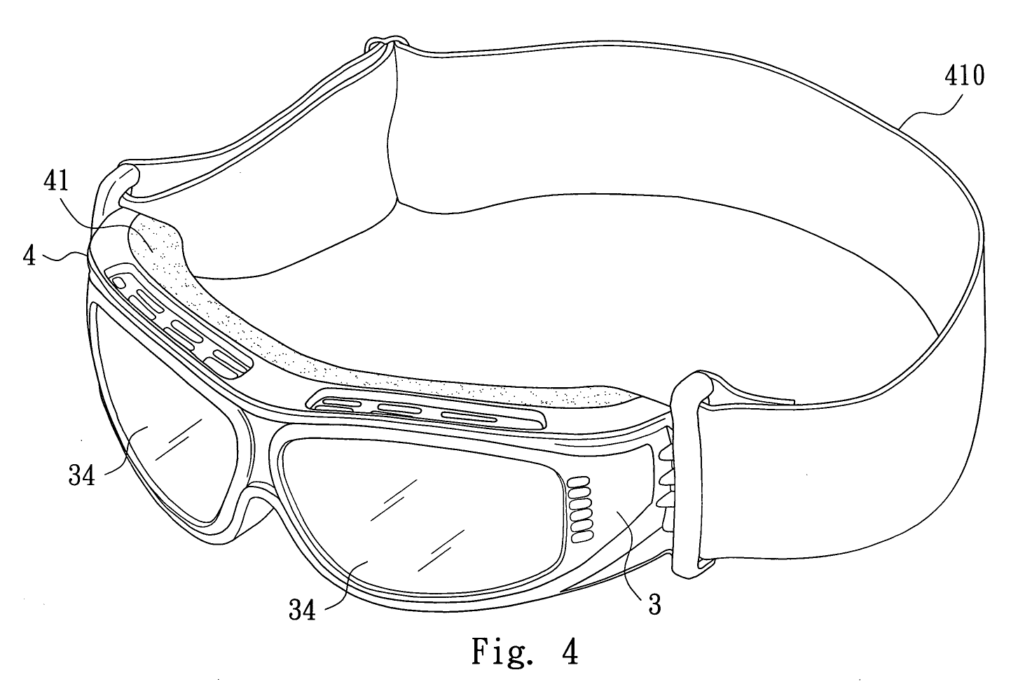

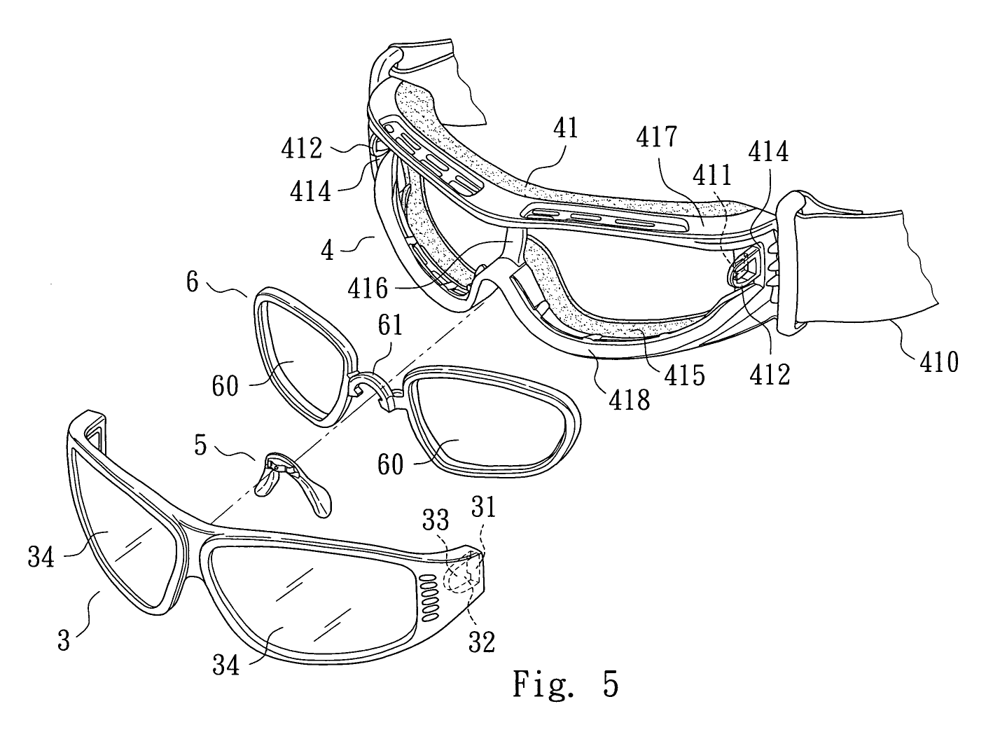

A pair of glasses of second type according to the preferred teachings of the present invention is shown in FIGS. 4 and 5 and includes a first frame 3 and two lenses 34 mounted in the first frame 3. The first frame 3 includes two ends each having a groove 32 defined therein. The groove 32 includes an end opening 31 facing a rear of the first frame 3 and a side opening 33 in a lateral face (e.g., the inner face) thereof and extending in a direction transverse to the rear opening 31. A nose pad 5 is mounted to an inner side of the first frame 3. Removably mounted to the nose pad 5 is a pair of optical glasses 6 including two corrective lenses 6 for correcting myopia, hyperopia, or astigmatism and a connecting member 61 between the corrective lenses 60. The connecting member 61 is coupled with the nose pad 5, with the pair of optical glasses 60 located behind the first frame 3 and with the corrective lenses 60 aligned with the lenses 34. The lenses 34 may be sunglass lenses. Thus, a user may obtain sunlight shielding effect as well as eyesight correction effect. Nevertheless, the lenses 34 may be corrective lenses when desired. The first frame 3 may receive only one lens, and the shape of the first frame 3 may be modified according to the shape of the lens. Similarly, the pair of optical glasses 6 may include only one corrective lens if desired, and the shape of the pair of optical glasses 6 may be modified according to need.

The pair of glasses further includes a wearing portion 4 allowing the pair of glasses to be worn on a head of a user. According to the preferred form shown, the wearing portion 4 includes a second frame 41 with a head strap 410 having two ends attached to two ends of the second frame 41. The second frame 41 is a glasses frame for sports, leisure, eye-protection, or wind-shielding. The second frame 41 includes a compartment 415 extending from a front side through a rear side of the frame 41 for receiving the first frame 3 and the pair of optical glasses 6, with the pair of optical glasses 6 securely sandwiched between the first frame 3 and the second frame 41. A stop 416 is formed in the compartment 415 between intermediate portions of upper and lower walls 417 and 418 defining the compartment 415. The stop 41 prevents the pair of optical glasses 6 and the first frame 3 from disengaging from the compartment 415 via a rear side of the second frame 41. The second frame 41 further includes two sidewalls 414 defining the compartment 415. An engaging member 412 is formed on each sidewall 414 and includes a resilient tenon 411. The engaging member 412 is inserted into one of the grooves 32 of the first frame 3 via the end opening 31, with the resilient tenon 414 engaged with the side opening 33. The resilient tenon 411 can be pressed into the groove 32 and, thus, disengage from the side opening 33, allowing removal of the engaging member 411 from the groove 32. Thus, the first frame 3 can be detached from the compartment 415 of the second frame 41 when desired. When the first frame 3 is coupled with the second frame 41, a pair of glasses with multiple functions is provided. Namely, the pair of glasses according to the preferred teachings of the present invention can be utilized during sports and leisure, shielding the eyes of the user from sunlight and wind while providing an eyesight correction effect.

Although specific embodiments have been illustrated and described, numerous modifications and variations are still possible. The scope of the invention is limited by the accompanying claims.

What is claimed is:

1. A pair of glasses comprising:
a frame including an end having a groove defined therein, with the groove including an end opening facing a rear of the frame, with the groove further including a side opening in a lateral face of the end of the frame;
a wearing portion including an engaging member having a resilient tenon,
with the engaging member being removably engaged with the groove of the frame via the end opening, with the resilient tenon being engaged with the side opening, and
with the resilient tenon of the engaging member being pressable into the groove of the frame to disengage from the side opening, allowing removal of the engaging member from the groove.

2. The pair of glasses as claimed in claim 1, with the wearing portion being a temple having an end on which the engaging member is formed.

3. The pair of glasses as claimed in claim 1, with the frame including an inner side, with the pair of glasses further comprising, in combination: a nose pad removably mounted to the inner side of the frame; and a pair of optical glasses removably mounted to the nose pad and including at least one corrective lens for correcting one of myopia, hyperopia, or astigmatism.

4. A pair of glasses comprising:
a first frame including an end having a groove defined therein, with the groove including an end opening facing a rear of the first frame, with the groove further including a side opening in a lateral face of the end of the first frame;
a wearing portion including a second frame and a head strap attached to the second frame, with the second frame being a glasses frame for sports, leisure, eye-protection, or wind-shielding, with the second frame receiving the first frame, with the second frame further including an engaging member having a resilient tenon,
with the engaging member being removably engaged with the groove of the first frame via the end opening, with the resilient tenon being engaged with the side opening of the groove of the first frame, and
with the resilient tenon of the engaging member being pressable into the groove to disengage from the side opening of the groove, allowing removal of the engaging member from the groove.

5. The pair of glasses as claimed in claim 4, with the first frame including an inner side, with the pair of glasses further comprising, in combination: a nose pad removably mounted to the inner side of the frame; and a pair of optical glasses removably mounted to the nose pad and including at least one corrective lens for correcting one of myopia, hyperopia, or astigmatism, with the pair of optical glasses being sandwiched between the first frame and the second frame.
